(19) United States
(12) Patent Application Publication
(10) Pub. No.: US 2025/0324218 A1
(43) Pub. Date: Oct. 16, 2025

(54) COMPUTER READABLE MEDIUM AND IN-VEHICLE SOUND DEVICE FOR CONVERTING IN-VEHICLE AUDIO INTO SURROUND SOUND

(71) Applicant: BO TAN, Berkeley, CA (US)

(72) Inventors: Bo Tan, Berkeley, CA (US); Shaopeng Liu, Suzhou (CN)

(73) Assignee: BO TAN, Berkeley, CA (US)

(21) Appl. No.: 19/095,347

(22) Filed: Mar. 31, 2025

Related U.S. Application Data
(63) Continuation-in-part of application No. 18/902,105, filed on Sep. 30, 2024, now Pat. No. 12,289,593.

(30) Foreign Application Priority Data
Apr. 10, 2024 (CN) 2024104242323

(51) Int. Cl. H04S 7/00

(52) U.S. Cl. CPC H04S 7/305; H04R 2499/13

(57) ABSTRACT

A non-transitory computer readable medium and an in-vehicle sound device relating to convert a vehicle audio into a surround sound and a sound system are provided. The non-transitory computer readable medium stores a computer-program product includes instructions for extracting features of an audio data for debugging based on a vehicle audio signal; performing classification according to the extracted features to separate the audio data into a plurality of single audio signals; mixing the plurality of separated single audio signals, and recording parameters of the current sound mixing algorithm as original sound mixing parameters; pre-configuring a plurality of spatial reverberation modes; debugging the original sound mixing parameters; and determining and saving optimized audio channel equalization parameters and optimized sound mixing parameters corresponding to the spatial reverberation modes as the multi-channel surround sound conversion parameters.

### CROSS-REFERENCE TO RELATED APPLICATIONS

This application is a continuation-in-part patent application of U.S. application Ser. No. 18/902,105 filed on Sep. 30, 2024, which claims the benefit of China Patent Application No. 202410424232.3 filed Apr. 10, 2024, the entire contents of which are incorporated herein by reference in its entirety.

### TECHNICAL FIELD

The present disclosure relates to the field of processing and application of audio signals, and in particular, to a non-transitory computer readable medium and in-vehicle sound device for converting in-vehicle audio into surround sound.

### BACKGROUND

As an important component of an in-vehicle entertainment device, an in-vehicle sound system aims to bring a good driving experience to a user by playing an audio in a vehicle cabin, but the existing in-vehicle sound system has the following problems:
first, an immersive experience is poor: although in-vehicle surround sound systems can create a broader sound field inside a vehicle, immersion of some in-vehicle audio systems is still weak possibly due to quality of loudspeakers, acoustic design inside the vehicle, lack of high quality multi-channel sound source content, or the like; and
second, limitation of an upmixing technology exists: the traditional upmixing technology, such as stereo flipping and subtraction, is still used in some in-vehicle surround sound systems, and the method may result in a loss of tone quality and a poor effect, and cannot provide a satisfactory listening experience.

Although some advanced in-vehicle surround sound audio processing algorithms are gradually developed at present to improve the effect of the upmixing technology, the problem that the insufficient multi-channel sound source content is required to be made up still exists, such that multi-channel music is required to be made, which requires professional technologies and devices, and specific encoding and decoding standards are required to be met; in order to solve limitation of sound coloration and music detail adjustment, the in-vehicle audio system is also required to provide various sound effects, spatial effects and preset options.

In summary, the existing in-vehicle surround sound audio technology still has a limited music detail adjustment function, and the in-vehicle surround sound system faces the challenge of the insufficient multi-channel sound source content. Moreover, with a development of the technology and an increase of a demand, more sound source content is expected to be available, and more streaming media platforms and hardware devices are expected to support a multi-channel audio; therefore, there is an urgent need in the market for more advanced processing algorithms and surround sound source content to provide a more excellent in-vehicle surround sound audio experience.

The disclosure of the above background is only used for assisting understanding of the inventive concept and technical solutions of the present disclosure, and it does not necessarily belong to the prior art of the present patent application, nor does it necessarily give technical teaching; the above background should not be used to assess the novelty and inventiveness of the present application in the event that there is no clear evidence that the above disclosure is made prior to the filing date of the present patent application.

### SUMMARY

An object of the present disclosure provides a non-transitory computer readable medium storing a computer-program product embodied in a non-transitory computer readable medium that is programmed to generate an audio output, which is applied to customizing multi-channel surround sound conversion parameters for an automobile of a target model, to simulate a real surround sound space effect and provide a better immersive experience.
disclosure The computer-program product comprising instructions for:
acquiring an in-vehicle audio signal for debugging from the automobile of the target model, and decoding the in-vehicle audio signal for debugging to obtain audio data for debugging in a preset standard format;
extracting features of the audio data for debugging, the extracted features including time domain features and frequency domain features;
performing classification according to the extracted features by using an audio separation model, so as to separate the audio data for debugging into a plurality of single audio signals for debugging, different single audio signals for debugging being located in different audio tracks;
mixing the plurality of separated single audio signals for debugging by using a sound mixing algorithm, and recording parameters of the current sound mixing algorithm as original sound mixing parameters;
pre-configuring a plurality of spatial reverberation modes, and performing the following debugging for each spatial reverberation mode: debugging an equalization parameter of the audio track; and debugging the original sound mixing parameters; and
determining and saving optimized audio track equalization parameters and optimized sound mixing parameters corresponding to the spatial reverberation modes as the multi-channel surround sound conversion parameters.

In an embodiment, in accordance with any one or a combination of the foregoing technical solutions, the debugging is performed for the spatial reverberation mode by:
presetting various evaluation factors and corresponding weights for audio tone quality;
operating an in-vehicle sound system multiple times;
obtaining a score of each evaluation factor for each operation, and calculating a tone quality score of the operation in conjunction with the corresponding weights; and
performing a preset number of operations, and selecting an equalization parameter of the audio track and a sound mixing parameter under an operation corresponding to a highest tone quality score as the optimized audio track equalization parameter and the optimized sound mixing parameter respectively; or stopping the operation of the in-vehicle sound system when the tone quality score reaches a preset optimization score threshold, and taking an equalization parameter of the audio track and a sound mixing parameter under a last operation as the optimized audio track equalization parameter and the optimized sound mixing parameter respectively.

In an embodiment, in accordance with any one or a combination of the foregoing technical solutions, the spatial reverberation mode includes a board reverberation mode, a room reverberation mode and a hall reverberation mode;
the tone quality evaluation factors and/or weight distribution corresponding to different reverberation modes are not completely the same.

Further, in accordance with any one or a combination of the foregoing technical solutions, the audio separation model is an AI model which is obtained by performing training by:
collecting a plurality of learning samples, each learning sample including audio data, and corresponding time domain features and frequency domain features;
manually marking each learning sample to obtain a label separated into a plurality of pieces of single audio information;
inputting the learning samples and the corresponding labels into a basic model, and performing iterative training; and
obtaining the audio separation model when the basic model converges.

In an embodiment, in accordance with any one or a combination of the foregoing technical solutions, the performing debugging for each spatial reverberation mode further includes:
manually checking the plurality of single audio signals for debugging separated by the audio separation model;
if the check is passed, keeping the current single audio signal for debugging; and
if the check is not passed, adjusting and updating the single audio signal for debugging, acquiring a new learning sample and a corresponding label accordingly, and performing further optimization training on the audio separation model.

In an embodiment, in accordance with any one or a combination of the foregoing technical solutions, before the mixing the plurality of separated single audio signals for debugging, the non-transitory computer readable medium further includes instructions for:
determining a surround sound track of the in-vehicle sound system of the target model; and
selecting a matched sound mixing algorithm according to the surround sound track.

In an embodiment, in accordance with any one or a combination of the foregoing technical solutions, when the surround sound track is a front left audio track, a front center audio track, a front right audio track, a rear left audio track, and a rear right audio track, a 5.1 sound mixing algorithm is selected;
or, when the surround sound track is a front left audio track, a front center audio track, a front right audio track, a left audio track, a right audio track, a rear left audio track, a rear right audio track, and a low frequency effect audio track, a 7.1 sound mixing algorithm, or a 7.1.2 sound mixing algorithm, or a 7.1.4 sound mixing algorithm is selected.

In an embodiment, in accordance with any one or a combination of the foregoing technical solutions, the non-transitory computer readable medium further includes instructions for:
adjusting parameters of the sound mixing algorithm by one or more of the following manners:
calibrating an initial frequency response to enable each loudspeaker in the target model to realize a frequency response curve reaching preset flatness;
correcting a delay time of the loudspeaker, and adjusting the output delay time of each loudspeaker according to a position relationship between each loudspeaker in the target model and a target seat in the automobile;
adjusting virtual positions by adjusting volume and the output delay times of the loudspeakers in the target model to enable the virtual positions of the loudspeakers to surround the target seat; and
adjusting settings of a compressor and a limiter of the in-vehicle sound system.

In an embodiment, in accordance with any one or a combination of the foregoing technical solutions, the in-vehicle audio signal is acquired by:
receiving an audio signal through one or more of an in-vehicle media player, an in-vehicle Bluetooth interface and an in-vehicle USB interface as the in-vehicle audio signal.

In an embodiment, in accordance with any one or a combination of the foregoing technical solutions, the standard-format audio data obtained by decoding the in-vehicle audio signal is audio data in a PCM format.

In an embodiment, in accordance with any one or a combination of the foregoing technical solutions, the non-transitory computer readable medium further includes instructions for:
providing a human-computer interaction apparatus electrically connected with the in-vehicle sound system;
controlling performance parameters of the in-vehicle sound system by the human-computer interaction apparatus to obtain a personalized sound effect setting; and
saving the personalized sound effect setting, the saved personalized sound effect setting being allowed to be called subsequently.

A second aspect of the present disclosure provides an in-vehicle sound device, which includes a processor and the non-transitory computer readable medium, wherein the processor is configured to execute the instructions to convert an in-vehicle audio into a multi-channel surround sound, and output an obtained result audio signal to a loudspeaker.

In an embodiment, the processor is configured to save and call the personalized sound effect setting.

In an embodiment, the device further includes:
a first interface for acquiring the in-vehicle audio signal for debugging from the automobile of target model;
a second interface for outputting a mixed result audio signal to a loudspeaker; and
a power supply for supply power to the processor and the non-transitory computer readable medium.

A third aspect of the present disclosure provides a method for converting an in-vehicle audio into a multi-channel surround sound, including the following steps:
based on the parameter debugging method as mentioned above, acquiring multi-channel surround sound conversion parameters including optimized audio track equalization parameters and optimized sound mixing parameters corresponding to various spatial reverberation modes of a target model;
acquiring a target in-vehicle audio signal from an automobile of the target model, and decoding the target in-vehicle audio signal to obtain target audio data in a standard format;
extracting features of the target audio data, the extracted features including time domain features and frequency domain features;
performing classification according to the extracted features by using an audio separation model, so as to separate the target audio data into a plurality of target single audio signals, different target single audio signals being located in different audio tracks;
determining a corresponding optimized audio track equalization parameter and optimized sound mixing parameter according to a target spatial reverberation mode selected from the plurality of preconfigured spatial reverberation modes;
processing the target single audio signal located in each audio track by using the optimized audio track equalization parameter to obtain each equalized single audio signal;
mixing the equalized single audio signals by using the optimized sound mixing parameters to obtain a result audio signal; and
outputting the mixed result audio signal.

Further, in accordance with any one or a combination of the foregoing technical solutions, the outputting the mixed result audio signal by an in-vehicle loudspeaker includes:
matching corresponding power and driving capability according to the result audio signal; and
controlling the loudspeaker driving capability and loudspeaker output power according to the matching result.

In an embodiment, in accordance with any one or a combination of the foregoing technical solutions, after the acquiring a target in-vehicle audio signal from an automobile of the target model, the method further includes:
identifying the target in-vehicle audio signal, and judging whether the target in-vehicle audio signal belongs to a rendering avoiding audio type, the rendering avoiding audio type including a navigation audio, a telephone audio and an alarm system audio; and
if yes, directly outputting the target in-vehicle audio signal to the in-vehicle loudspeaker without performing the method for converting an in-vehicle audio into a multi-channel surround sound.

In an embodiment, in accordance with any one or a combination of the foregoing technical solutions, the method further includes:
providing a microphone interface configured to connect a microphone apparatus with an in-vehicle sound system; and
receiving an audio signal through one or more of an in-vehicle media player, an in-vehicle Bluetooth interface, an in-vehicle USB interface and the microphone interface as the target in-vehicle audio signal.

A fourth aspect of the present disclosure provides an in-vehicle sound system, including a loudspeaker and a processor, wherein the processor is configured to execute any one of the above-mentioned method for converting an in-vehicle audio into a multi-channel surround sound, and output an obtained result audio signal to the loudspeaker.

In an embodiment, in accordance with any one or a combination of the foregoing technical solutions, the in-vehicle sound system further includes a human-computer interaction apparatus electrically connected with the processor;

the human-computer interaction apparatus is configured to control performance parameters of the in-vehicle sound system to obtain a personalized sound effect setting;
the processor is configured to save and call the personalized sound effect setting.

The technical solution of the present disclosure has the following beneficial effects:
a. by adopting an advanced sound field simulation algorithm, the real surround sound space effect can be more accurately simulated, and the better immersive experience can be provided;
b. self-developed music analysis and the separation model are used, a sound source positioning technology and a sound mixing algorithm are combined, fine space effect rendering is performed through an in-vehicle server device, and the surround sound is output to an in-vehicle infotainment system, such that a texture of music is improved, and meanwhile, a tone color of the music is not changed, layers and details of the music are clearer, a sound field is wider, and strict requirements of music buffs for the tone quality are met;
c. more audio parameters and equalizer settings are provided, such that a user can customize the details of the music and adjust the sound effect, so as to realize a more personalized listening experience; the stereo music is automatically rendered into the in-vehicle immersive surround sound, thereby bringing a concert-hall-level listening experience to drivers and passengers, greatly enriching a selection range of surround sound source content and providing more diversified immersive experiences.

### BRIEF DESCRIPTION OF THE DRAWINGS

To describe the technical solution of the embodiments of the present application or the prior art more clearly, the following briefly describes the accompanying drawings required for describing the embodiments or the prior art. Apparently, the accompanying drawings in the following description show merely some embodiments of the present application, and a person of ordinary skill in the art may still derive other drawings from these accompanying drawings without creative efforts.

FIG. 1 is a schematic diagram of a parameter debugging method for converting an in-vehicle audio into a surround sound according to an exemplary embodiment of the present disclosure;

FIG. 2 is a conceptual diagram of conversion of an in-vehicle audio into a multi-channel surround sound in an exemplary embodiment of the present disclosure;

FIG. 3 is a flowchart of a method for converting an in-vehicle audio into a multi-channel surround sound according to an exemplary embodiment of the present disclosure;

FIG. 4 is a histogram of a stereo audio before an improvement;

FIG. 5 is an audio histogram of a converted multi-channel surround sound in an exemplary embodiment of the present disclosure;

FIG. 6 is a width measurement diagram of a stereo sound before an improvement;

FIG. 7 is a width measurement diagram of a converted multi-channel surround sound in an exemplary embodiment of the present disclosure;

FIG. 8 is an equalization graph of the stereo sound before the improvement; and

FIG. 9 is an equalization graph of a converted multi-channel surround sound in an exemplary embodiment of the present disclosure.

### DETAILED DESCRIPTION

In order to make those skilled in the art better understand the technical solutions of the present disclosure, the technical solutions in the embodiments of the present disclosure are clearly and completely described with reference to the accompanying drawings in the embodiments of the present disclosure, and apparently, the described embodiments are not all but only a part of the embodiments of the present disclosure. All other embodiments obtained by a person of ordinary skill in the art based on the embodiments of the present disclosure without creative efforts shall fall within the protection scope of the present disclosure.

It should be noted that the terms “first”, “second”, or the like, in the description and claims of the present disclosure and in the foregoing drawings are used for distinguishing between similar objects and not necessarily for describing a particular sequential or chronological order. It should be understood that data thus used is interchangeable in proper circumstances, such that the embodiments of the present disclosure described herein can be implemented in orders except the orders illustrated or described herein. Furthermore, the terms “include”, “have” and any variation thereof are intended to cover a non-exclusive inclusion; for example, a process, method, apparatus, product, or device including a list of steps or units is not necessarily limited to those steps or units expressly listed, but may include other steps or units not expressly listed or inherent to the process, method, product, or device.

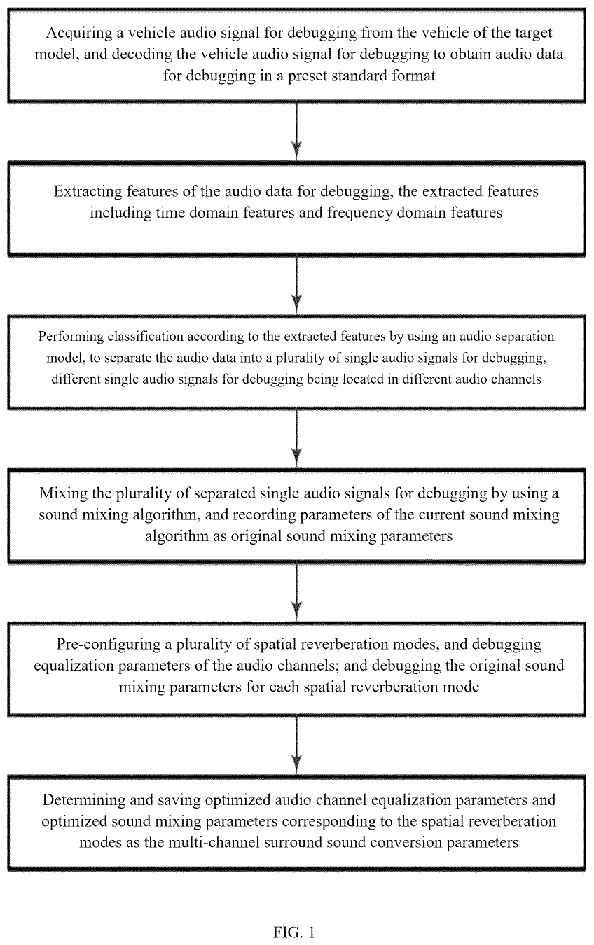

In an embodiment of the present disclosure, referring to FIG. 1, a parameter debugging method for converting an in-vehicle audio into a multi-channel surround sound is provided, which is applied to customizing multi-channel surround sound conversion parameters for an automobile of a target model, the parameter debugging method including the following steps:

first step: acquiring an in-vehicle audio signal for debugging from the automobile of the target model, and decoding the in-vehicle audio signal for debugging to obtain audio data for debugging in a preset standard format.

Specifically, an audio signal is received through one or more of an in-vehicle media player, an in-vehicle Bluetooth interface and an in-vehicle USB interface as the in-vehicle audio signal; the standard-format audio data obtained by decoding the in-vehicle audio signal is audio data in a PCM format.

Second step: extracting features of the audio data for debugging, the extracted features including time domain features and frequency domain features; specifically, the time domain features including amplitude, tone color, or the like; the frequency domain features including frequency spectrum, frequency, or the like.

Third step: performing classification according to the extracted features by using an audio separation model, so as to separate the audio data for debugging into a plurality of single audio signals for debugging, different single audio signals for debugging being located in different audio tracks.

Specifically, the audio separation model is an AI model in which structures of a convolutional neural network and a long-short term memory neural network are used to construct an encoder-decoder model configured to learn a music time structure and parse separated waveforms corresponding to a plurality of single sound sources in a target audio signal.

The specific method for constructing the encoder-decoder model is disclosed in Chinese Patent Application No. CN117295004A and includes: constructing an initial model based on the convolutional neural network and the long-short term memory neural network, a plurality of CNN layers and a plurality of LSTM layers being configured in the initial model; extracting features of all sections in an input signal by utilizing the CNN layers to generate CNN features of all the sections; performing space modeling on all the sections of the input signal based on the CNN features; processing the CNN features by utilizing the LSTM layers to generate LSTM features of all the sections; and performing time modeling on the CNN features and all the sections based on the LSTM features.

A training mode of the AI model with the structures of the convolutional neural network and the long-short term memory neural network is also disclosed in Chinese Patent Application No. CN117295004A: separated waveforms of a human voice and/or various musical instruments and a full waveform of a mixed audio are collected, and the separated waveforms and the full waveform are manually marked with classification labels respectively as a learning sample set for model training and verification; for example, for various songs, waveforms of the human voice, background music and various musical instruments are manually separated by an audio engineer, and the waveforms are marked; for example, one waveform is marked as piano, and the other waveform is marked as human voice.

A plurality of learning samples are collected, each learning sample including audio data, and corresponding time domain features and frequency domain features; each learning sample is manually marked to obtain a label separated into a plurality of pieces of single audio information; the learning samples and the corresponding labels are input into a basic model, and iterative training is performed; and the audio separation model is obtained when the basic model converges.

The learning sample set is input into the initial model after space modeling and time modeling, and the initial model learns to extract time-frequency features of the human voice, background music and/or musical instruments; that is, the model learns to identify various waveforms from the full waveform, and multi-target learning of the initial model is realized in a time-frequency mask mode to obtain the encoder-decoder model capable of predicting the separated waveforms.

The encoder-decoder model outputs the corresponding classification label of the separated waveform while outputting a prediction result of the separated waveform; therefore, a sound source attribute matched with the separated waveform can be identified according to the corresponding classification label, a corresponding audio element is further separated, and the audio element is associated with the classification label, so as to realize feature marking of the separated audio element according to the preset classification label.

Fourth step: mixing the plurality of separated single audio signals for debugging by using a sound mixing algorithm, and recording parameters of the current sound mixing algorithm as original sound mixing parameters.

Specifically, a surround sound track of the in-vehicle sound system of the target model is determined, and then, a matched sound mixing algorithm is selected according to the surround sound track; exemplarily, when the surround sound track is a front left audio track, a front center audio track, a front right audio track, a rear left audio track, and a rear right audio track, a 5.1 sound mixing algorithm is selected; or when the surround sound track is a front left audio track, a front center audio track, a front right audio track, a left audio track, a right audio track, a rear left audio track, a rear right audio track, and a low frequency effect audio track, a 7.1 sound mixing algorithm, or a 7.1.2 sound mixing algorithm, or a 7.1.4 sound mixing algorithm is selected, and the algorithms can mix separated audio signals to achieve a surround sound effect suitable for an acoustic environment inside the vehicle.

In addition to determining/selecting the sound mixing algorithm, parameters thereof may be adjusted by one or more of the following ways:
calibrating an initial frequency response to enable each loudspeaker in the target model to realize a frequency response curve reaching preset flatness; and/or correcting a delay time of the loudspeaker, and adjusting the output delay time of each loudspeaker according to a position relationship between each loudspeaker in the target model and a target seat in the automobile; and/or adjusting virtual positions by adjusting volume and the output delay times of the loudspeakers in the target model to enable the virtual positions of the loudspeakers to surround the target seat; and/or adjusting settings of a compressor and a limiter of the in-vehicle sound system, so as to optimize the surround sound effect and tone quality.

Fifth step: pre-configuring a plurality of spatial reverberation modes, and performing the following debugging for each spatial reverberation mode: \textcircled{1} debugging an equalization parameter of the audio track; and \textcircled{2} debugging the original sound mixing parameters.

Specifically, the spatial reverberation mode includes a board reverberation mode, a room reverberation mode and a hall reverberation mode; the tone quality evaluation factors and/or weight distribution corresponding to different reverberation modes are not completely the same, and a user can select effects of different simulation spaces according to preference.

Specifically, the debugging is performed for the spatial reverberation mode by:
presetting various evaluation factors and corresponding weights for audio tone quality; exemplarily, the evaluation factors including volume, dynamic performance, distortion, spatiality, or the like;
operating an in-vehicle sound system multiple times;
obtaining a score of each evaluation factor for each operation, and calculating a tone quality score of the operation in conjunction with the corresponding weights; and
performing a preset number of operations, and selecting an equalization parameter of the audio track and a sound mixing parameter under an operation corresponding to a highest tone quality score as the optimized audio track equalization parameter and the optimized sound mixing parameter respectively.

In an alternative embodiment, the specific number of the operations may not be set, and the in-vehicle sound system is operated until the tone quality score reaches a preset optimization score threshold, and an equalization parameter of the audio track and a sound mixing parameter under a last operation are taken as the optimized audio track equalization parameter and the optimized sound mixing parameter respectively.

In an embodiment of the present disclosure, the performing debugging for each spatial reverberation mode further includes: manually checking the plurality of single audio signals for debugging separated by the audio separation model; if the check is passed, keeping the current single audio signal for debugging; and if the check is not passed, adjusting and updating the single audio signal for debugging, acquiring a new learning sample and a corresponding label accordingly, and performing further optimization training on the audio separation model.

Sixth step: determining and saving optimized audio track equalization parameters and optimized sound mixing parameters corresponding to the spatial reverberation modes as the multi-channel surround sound conversion parameters.

Based on the above six steps, the multi-channel surround sound conversion parameters can be obtained. Obviously, the conversion parameter is allowed to be further manually adjusted to meet personalization requirements, and in such an embodiment, a human-computer interaction apparatus may be provided and electrically connected with the in-vehicle sound system; performance parameters of the in-vehicle sound system are controlled by the human-computer interaction apparatus to obtain a personalized sound effect setting; and the personalized sound effect setting is saved, the saved personalized sound effect setting being allowed to be called subsequently. In this way, on the basis of the multi-channel surround sound conversion parameter obtained by the above-described embodiment, the user is allowed to perform manual fine adjustment to obtain a personalized surround sound preferred by the user, and to save the personalized setting for subsequent reuse.

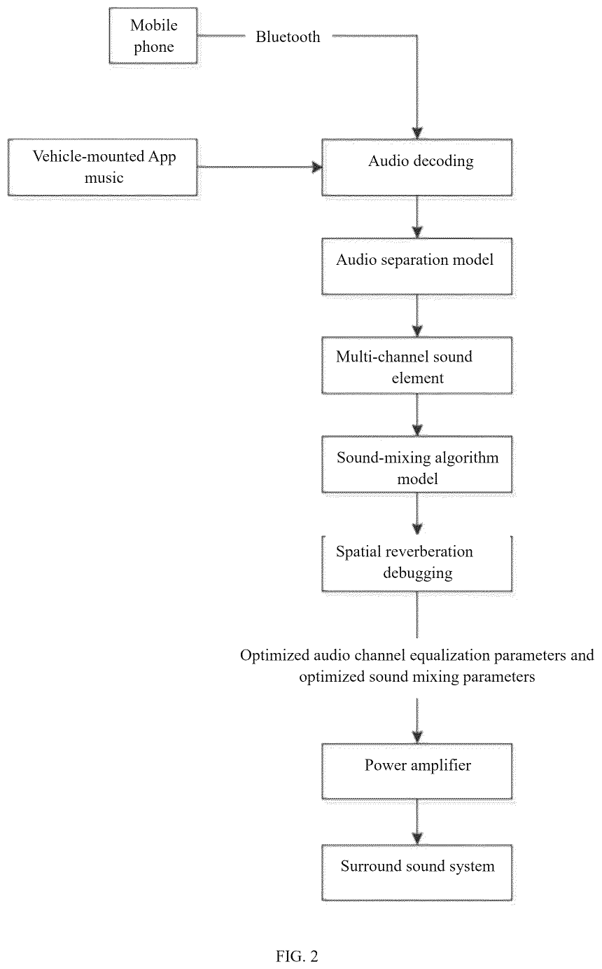

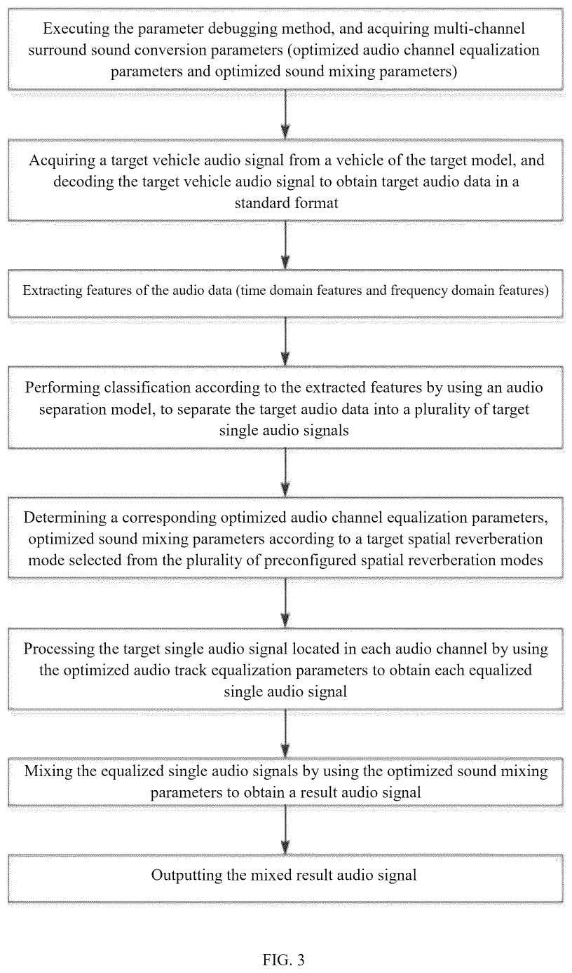

In an embodiment of the present disclosure, there is provided a method for converting an in-vehicle audio into a multi-channel surround sound, referring to FIG. 3, including the following steps:
based on the parameter debugging method as mentioned in the above embodiment, acquiring multi-channel surround sound conversion parameters including optimized audio track equalization parameters and optimized sound mixing parameters corresponding to various spatial reverberation modes of a target model, which is a premise of conversion of the multi-channel surround sound;
acquiring a target in-vehicle audio signal from an automobile of the target model, and decoding the target in-vehicle audio signal to obtain target audio data in a standard format; wherein as shown in FIG. 2, the target in-vehicle audio signal can be acquired through vehicle-mounted App or through Bluetooth connection with a mobile phone;
extracting features of the target audio data, the extracted features including time domain features and frequency domain features;
performing classification according to the extracted features by using an audio separation model, so as to separate the target audio data into a plurality of target single audio signals, different target single audio signals being located in different audio tracks; wherein as shown in FIG. 2, the audio separation model separates the sound into multi-track sound elements;
determining a corresponding optimized audio track equalization parameter and optimized sound mixing parameter according to a target spatial reverberation mode selected from the plurality of preconfigured spatial reverberation modes, as shown in FIG. 2;
processing the target single audio signal located in each audio track by using the optimized audio track equalization parameter to obtain each equalized single audio signal;
mixing the equalized single audio signals by using the optimized sound mixing parameters to obtain a result audio signal; and
outputting the mixed result audio signal, wherein specifically, as shown in FIG. 2, the outputting the mixed result audio signal by an in-vehicle loudspeaker includes: matching corresponding power and driving capability according to the result audio signal; and controlling the loudspeaker driving capability and loudspeaker output power according to the matching result. The required power and driving capability can be provided for the loudspeaker by selecting a proper power amplifier and amplifier.

In an embodiment of the present disclosure, after the acquiring a target in-vehicle audio signal from an automobile of the target model, the method further includes: identifying the target in-vehicle audio signal, and judging whether the target in-vehicle audio signal belongs to a rendering avoiding audio type, the rendering avoiding audio type including a navigation audio, a telephone audio and an alarm system audio; and if yes, directly outputting the target in-vehicle audio signal to the in-vehicle loudspeaker without performing the method for converting an in-vehicle audio into a multi-channel surround sound.

In an embodiment of the present disclosure, the method for converting an in-vehicle audio into a multi-channel surround sound further includes: providing a microphone interface configured to connect a microphone apparatus with an in-vehicle sound system; and receiving an audio signal through one or more of an in-vehicle media player, an in-vehicle Bluetooth interface, an in-vehicle USB interface and the microphone interface as the target in-vehicle audio signal, so as to provide the user with the service of Karaoke in the vehicle and optimization of output sound quality of the Karaoke.

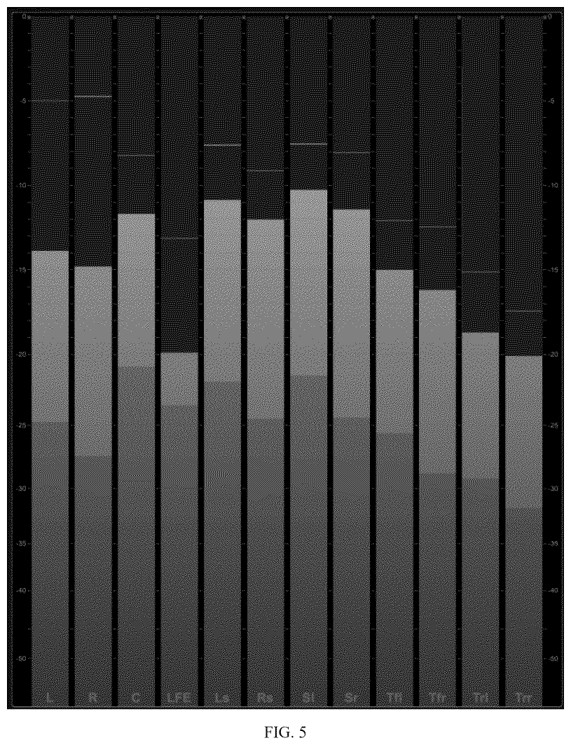

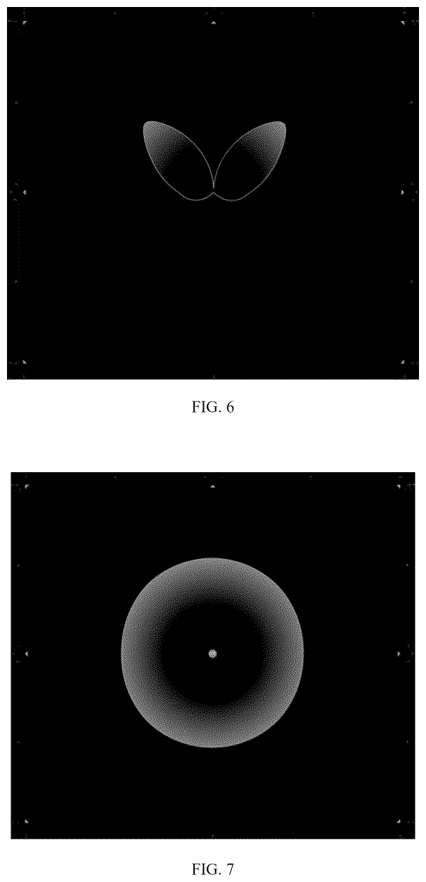

Characteristics (audio frequency, width and equalization) of the surround sound obtained by implementing the method for converting an in-vehicle audio into a multi-channel surround sound according to the embodiment of the present disclosure are shown in FIG. 5, FIG. 7 and FIG. 9 respectively.

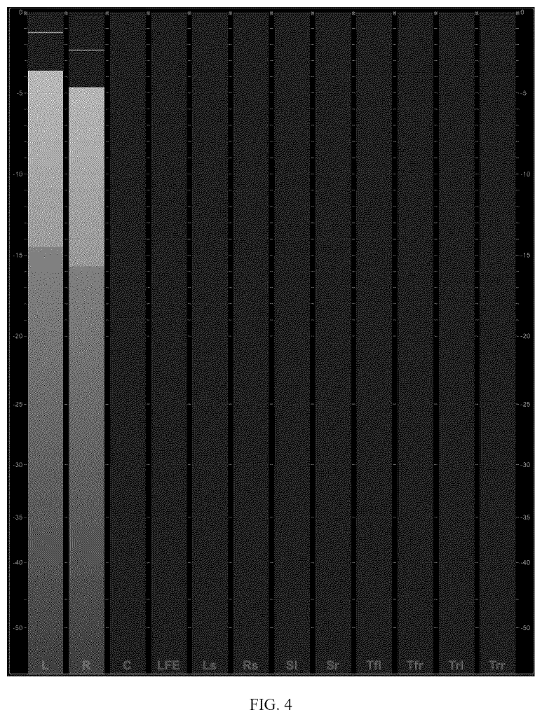

The audio histogram of the converted multi-channel surround sound shown in FIG. 5 is compared with the audio histogram of the sound signal before conversion shown in FIG. 4, the audio histogram is mainly used for embodying a number of channels and energy comparison of the audio signal, and since all sound elements can only be placed on left and right tracks (see FIG. 4), a traditional stereo sound has a large volume and is crowded; all sound elements of the 7.1.4 surround sound rendered by the conversion method according to the embodiment of the present disclosure can be dispersed in 12 tracks (see FIG. 5), and the sound is not crowded and is clearer.

By comparing the width measurement diagram of the converted multi-channel surround sound shown in FIG. 7 with the width measurement diagram of the sound signal before conversion shown in FIG. 6, it can be seen intuitively that the original stereo sound (see FIG. 6) has only left and right channels, such that the sound spreads in a butterfly shape, and the 7.1.4 surround sound rendered by the conversion method according to the embodiment of the present disclosure takes the user as a center (see FIG. 7) and circularly surrounds the user by 360 degrees, so as to give a strong immersion listening feeling.

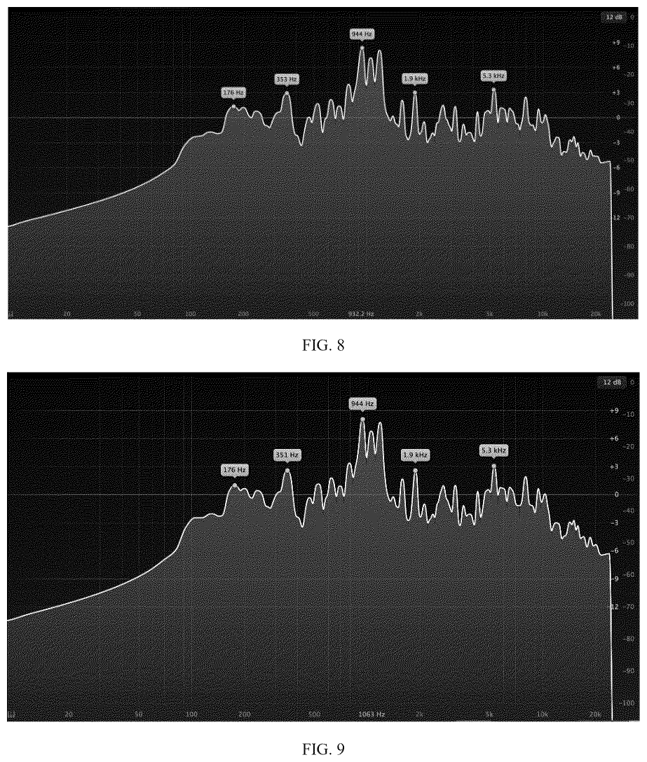

By comparing the equalization graph of the converted multi-channel surround sound shown in FIG. 9 with the equalization graph of the sound signal before conversion shown in FIG. 8, it can be seen that the equalization curve of the 7.1.4 surround sound rendered by the conversion method according to the embodiment of the present disclosure in FIG. 9 is highly consistent with that of the original music, and has no sound coloration; that is, the most original tone color of the music can be restored while the music immersion feeling is improved.

In an embodiment of the present disclosure, there is provided an in-vehicle sound system, including a loudspeaker and a processor, wherein the processor is configured to execute any one of the above-mentioned method for converting an in-vehicle audio into a multi-channel surround sound, and output an obtained result audio signal to the loudspeaker.

In an embodiment of the present disclosure, the sound system further includes a human-computer interaction apparatus electrically connected with the processor; the human-computer interaction apparatus is configured to control performance parameters of the in-vehicle sound system to obtain a personalized sound effect setting; the processor is configured to save and call the personalized sound effect setting. The human-computer interaction apparatus enables the user to easily control various parameters of the sound system, such as an element volume, a sound channel volume, a sound field setting, or the like; a user preference setting function is provided, and the user is allowed to save and call personalized sound effect settings, so as to meet requirements of different users.

Exemplarily, the human-computer interaction apparatus is integrated with a multimedia system of the vehicle, so as to ensure interconnectivity of the sound system and other functions of the vehicle.

In an embodiment, a computer-program product embodied in a non-transitory computer readable medium and a non-transitory computer readable medium are provided. The non-transitory computer readable medium stores a computer-program product embodied in a non-transitory computer readable medium that is programmed to generate an audio output according to the method shown in FIG. 1 or FIG. 3. The computer-program product includes instructions for:
acquiring an in-vehicle audio signal for debugging from an automobile of target model, and decoding the in-vehicle audio signal for debugging to obtain audio data for debugging in a preset standard format;
extracting features of the audio data for debugging, the extracted features comprising time domain features and frequency domain features;
performing classification according to the extracted features by using an audio separation model, so as to separate the audio data for debugging into a plurality of single audio signals for debugging, different single audio signals for debugging being located in different audio tracks;
determining a surround sound track of the in-vehicle sound system of the target model; selecting a matched sound mixing algorithm according to the surround sound track; mixing the plurality of separated single audio signals for debugging by using a sound mixing algorithm, and recording parameters of the current sound mixing algorithm as original sound mixing parameters;
pre-configuring a plurality of spatial reverberation modes, and performing the following debugging for each spatial reverberation mode: debugging an equalization parameter of the audio track; and debugging the original sound mixing parameters; wherein the debugging is performed for the spatial reverberation mode by: presetting various evaluation factors and corresponding weights for audio tone quality; operating an in-vehicle sound system multiple times; obtaining a score of each evaluation factor for each operation, and calculating a tone quality score of the operation in conjunction with the corresponding weights; and performing a preset number of operations, and selecting an equalization parameter of the audio track and a sound mixing parameter under an operation corresponding to a highest tone quality score as the optimized audio track equalization parameter and the optimized sound mixing parameter corresponding to the spatial reverberation mode respectively; or stopping the operation of the in-vehicle sound system when the tone quality score reaches a preset optimization score threshold, and taking an equalization parameter of the audio track and a sound mixing parameter under a last operation as the optimized audio track equalization parameter and the optimized sound mixing parameter corresponding to the spatial reverberation mode respectively; and
determining and saving optimized audio track equalization parameters and optimized sound mixing parameters corresponding to the spatial reverberation modes as multi-channel surround sound conversion parameters.

The non-transitory computer readable medium includes a computility chip, a memory and a solid-state storage. The computility chip is configured to implement the AI audio separation model and the multi-channel sound mixing algorithm. The memory includes a HBM (High Bandwidth Memory) and/or DRAM (Dynamic Random Access Memory), for storing the large amount of temporary data and intermediate results generated during operation. The solid-state storage is configured to store the operating system, algorithm model profiles, and related parameters, wherein the audio separation model and the multi-channel sound mixing algorithm is stored in the solid-state storage.

In an embodiment, an in-vehicle sound device is provided, which includes a processor and the non-transitory computer readable medium. The processor is configured to execute any one of the above-mentioned method for converting an in-vehicle audio into a multi-channel surround sound, and output an obtained result audio signal to the loudspeaker.

The in-vehicle sound device further includes a first interface for acquiring the in-vehicle audio signal for debugging from the automobile of target model, a second interface for outputting a mixed result audio signal to a loudspeaker, and a power supply for supply power to the processor and the non-transitory computer readable medium. The first interface is connected to the vehicle via a CAN bus, to receive the in-vehicle audio signal being PCM or WAV format. The in-vehicle audio signal is then transmitted to the computility chip, and the computility chip outputs a multichannel sound signal by implementing the AI audio separation model and the multi-channel sound mixing algorithm. The mixed result audio signal is sent to the speaker mounted on the vehicle by the second interface in format of 5.1 or 7.1.4.

It should be noted that herein, relational terms, such as first, second, or the like, may be used solely to distinguish one entity or operation from another entity or operation without necessarily requiring or implying any actual such relationship or order between such entities or operations. Moreover, the term “comprising”, “including”, or any other variant thereof is intended to encompass a non-exclusive inclusion, so that the process, method, article or device including a series of elements does not only include those elements, but also includes other elements not explicitly listed, or further includes inherent elements of the process, method, article or device. In cases where no further limitations are made, the element defined with the statement “including one . . . ” does not exclude the case that other identical elements further exist in the process, method, article or device including the elements.

The above is only the specific embodiments of the present application, and it should be noted that various improvements and adaptations can be made by those skilled in the art without departing from the principle of the application, and these improvements and adaptations should also be considered to be within the protection scope of the present application.

What is claimed is:

1. A non-transitory computer readable medium storing a computer-program product embodied in a non-transitory computer readable medium that is programmed to generate an audio output, the computer-program product comprising instructions for:
acquiring an in-vehicle audio signal for debugging from an automobile of target model, and decoding the in-vehicle audio signal for debugging to obtain audio data for debugging in a preset standard format;
extracting features of the audio data for debugging, the extracted features comprising time domain features and frequency domain features;
performing classification according to the extracted features by using an audio separation model, so as to separate the audio data for debugging into a plurality of single audio signals for debugging, different single audio signals for debugging being located in different audio tracks;
determining a surround sound track of the in-vehicle sound system of the target model; selecting a matched sound mixing algorithm according to the surround sound track; mixing the plurality of separated single audio signals for debugging by using a sound mixing algorithm, and recording parameters of the current sound mixing algorithm as original sound mixing parameters;
pre-configuring a plurality of spatial reverberation modes, and performing the following debugging for each spatial reverberation mode: debugging an equalization parameter of the audio track; and debugging the original sound mixing parameters; wherein the debugging is performed for the spatial reverberation mode by: presetting various evaluation factors and corresponding weights for audio tone quality; operating an in-vehicle sound system multiple times; obtaining a score of each evaluation factor for each operation, and calculating a tone quality score of the operation in conjunction with the corresponding weights; and performing a preset number of operations, and selecting an equalization parameter of the audio track and a sound mixing parameter under an operation corresponding to a highest tone quality score as the optimized audio track equalization parameter and the optimized sound mixing parameter corresponding to the spatial reverberation mode respectively; or stopping the operation of the in-vehicle sound system when the tone quality score reaches a preset optimization score threshold, and taking an equalization parameter of the audio track and a sound mixing parameter under a last operation as the optimized audio track equalization parameter and the optimized sound mixing parameter corresponding to the spatial reverberation mode respectively; and
determining and saving optimized audio track equalization parameters and optimized sound mixing parameters corresponding to the spatial reverberation modes as multi-channel surround sound conversion parameters.

2. The non-transitory computer readable medium according to claim 1, wherein the spatial reverberation mode comprises a board reverberation mode, a room reverberation mode and a hall reverberation mode;
the tone quality evaluation factors and/or weight distribution corresponding to different reverberation modes are not completely the same.

3. The non-transitory computer readable medium according to claim 1, wherein the audio separation model is an AI model which is obtained by performing training by:
collecting a plurality of learning samples, each learning sample comprising audio data, and corresponding time domain features and frequency domain features;
manually marking each learning sample to obtain a label separated into a plurality of pieces of single audio information;
inputting the learning samples and the corresponding labels into a basic model, and performing iterative training; and
obtaining the audio separation model when the basic model converges.

4. The non-transitory computer readable medium according to claim 3, wherein the performing debugging for each spatial reverberation mode further comprises:
manually checking the plurality of single audio signals for debugging separated by the audio separation model;
if the check is passed, keeping the current single audio signal for debugging; and
if the check is not passed, adjusting and updating the single audio signal for debugging, acquiring a new learning sample and a corresponding label accordingly, and performing further optimization training on the audio separation model.

5. The non-transitory computer readable medium according to claim 1, wherein when the surround sound track is a front left audio track, a front center audio track, a front right audio track, a rear left audio track, and a rear right audio track, a 5.1 sound mixing algorithm is selected;
or, when the surround sound track is a front left audio track, a front center audio track, a front right audio track, a left audio track, a right audio track, a rear left audio track, a rear right audio track, and a low frequency effect audio track, a 7.1 sound mixing algorithm, or a 7.1.2 sound mixing algorithm, or a 7.1.4 sound mixing algorithm is selected.

6. The non-transitory computer readable medium according to claim 1, further comprising an instruction for:
adjusting parameters of the sound mixing algorithm by one or more of the following manners:
calibrating an initial frequency response to enable each loudspeaker in the target model to realize a frequency response curve reaching preset flatness;
correcting a delay time of the loudspeaker, and adjusting the output delay time of each loudspeaker according to a position relationship between each loudspeaker in the target model and a target seat in the automobile;
adjusting virtual positions by adjusting volume and the output delay times of the loudspeakers in the target model to enable the virtual positions of the loudspeakers to surround the target seat; and
adjusting settings of a compressor and a limiter of the in-vehicle sound system.

7. The non-transitory computer readable medium according to claim 1, wherein the in-vehicle audio signal is acquired by:
receiving an audio signal through one or more of an in-vehicle media player, an in-vehicle Bluetooth interface and an in-vehicle USB interface as the in-vehicle audio signal.

8. The non-transitory computer readable medium according to claim 1, wherein the standard-format audio data obtained by decoding the in-vehicle audio signal is audio data in a PCM format.

9. The non-transitory computer readable medium according to claim 1, further comprising an instruction for:
providing a human-computer interaction apparatus electrically connected with the in-vehicle sound system;
controlling performance parameters of the in-vehicle sound system by a human-computer interaction apparatus to obtain a personalized sound effect setting, the human-computer interaction apparatus being electrically connected with the in-vehicle sound system; and
saving the personalized sound effect setting, the saved personalized sound effect setting being allowed to be called subsequently.

10. The non-transitory computer readable medium according to claim 1, further comprising instructions for:
acquiring a target in-vehicle audio signal from the automobile of the target model, and decoding the target in-vehicle audio signal to obtain target audio data in a standard format;
extracting features of the target audio data, the extracted features comprising time domain features and frequency domain features;
performing classification according to the extracted features by using an audio separation model, so as to separate the target audio data into a plurality of target single audio signals, different target single audio signals being located in different audio tracks;
determining a corresponding optimized audio track equalization parameter and optimized sound mixing parameter according to a target spatial reverberation mode selected from the plurality of preconfigured spatial reverberation modes;
processing the target single audio signal located in each audio track by using the optimized audio track equalization parameter to obtain each equalized single audio signal;
mixing the equalized single audio signals by using the optimized sound mixing parameters to obtain a result audio signal; and
outputting the mixed result audio signal.

11. The non-transitory computer readable medium according to claim 10, wherein the outputting the mixed result audio signal by an in-vehicle loudspeaker comprises:
matching corresponding power and driving capability according to the result audio signal; and
controlling the loudspeaker driving capability and loudspeaker output power according to the matching result.

12. The non-transitory computer readable medium according to claim 10, after the acquiring a target in-vehicle audio signal from an automobile of the target model, further comprising instructions for:
identifying the target in-vehicle audio signal, and judging whether the target in-vehicle audio signal belongs to a rendering avoiding audio type, the rendering avoiding audio type comprising a navigation audio, a telephone audio and an alarm system audio; and
if yes, directly outputting the target in-vehicle audio signal to the in-vehicle loudspeaker without converting an in-vehicle audio into a multi-channel surround sound.

13. The non-transitory computer readable medium according to claim 10, further comprising instructions for:
providing a microphone interface configured to connect a microphone apparatus with an in-vehicle sound system; and
receiving an audio signal through one or more of an in-vehicle media player, an in-vehicle Bluetooth interface, an in-vehicle USB interface and the microphone interface as the target in-vehicle audio signal.

14. An in-vehicle sound device, comprising a processor and a non-transitory computer readable medium of claim 1, wherein the processor is configured to execute the instructions to convert an in-vehicle audio into a multi-channel surround sound, and output an obtained result audio signal to a loudspeaker.

15. The in-vehicle sound device according to claim 14,
wherein the processor is configured to save and call the personalized sound effect setting.

16. The in-vehicle sound device according to claim 14, further comprising:
a first interface for acquiring the in-vehicle audio signal for debugging from the automobile of target model;
a second interface for outputting a mixed result audio signal to a loudspeaker; and
a power supply for supply power to the processor and the non-transitory computer readable medium.
